(19) United States
(12) Patent Application Publication
(10) Pub. No.: US 2007/0098963 A1
(43) Pub. Date: May 3, 2007

(54) Toner receiving compositions for electrophotographic toner receiving systems

(76) Inventors: Xiaoqi Zhou, San Diego, CA (US); Richard J. McManus, San Diego, CA (US); Hai Quang Tran, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/260,749

(22) Filed: Oct. 27, 2005

(51) Int. Cl. G03G 15/20; B41M 5/00

(52) U.S. Cl. 428/195.1; 430/124

(57) ABSTRACT

A toner receiving composition for electrophotographic toner receiving systems includes a binder of polymeric material and a plurality of organic hollow polymeric particles adhered to the polymeric binder material. The organic hollow polymeric particles are present in an amount equal to or greater than about 50% by weight of total solid weight of the toner receiving composition.

### BACKGROUND

The present disclosure relates generally to toner receiving compositions, and more particularly to toner receiving compositions for electrophotographic toner receiving systems.

Electrophotographic printing is widely used for both commercial and personal printing. The desire to produce photo-quality images poses a challenge, as achieving the look of photographs printed using silver halide technology may be difficult. Creating a superior, photo-quality image generally includes obtaining high image resolution and color gamut while minimizing printer/media artifacts. In addition to achieving these effects, it may also be desirable to maximize image toner transfer and to obtain a substantially high media gloss and a uniform gloss appearance for both the media and the toner. In electrophotographic printing devices that may not be capable of achieving a high gloss, it may be preferable to have a media gloss that provides a substantially uniform printed toner/media gloss appearance.

In order to achieve the desired effects, printing media are often coated with functional materials on the image receiving side. Such materials may, in some instances, be undesirable for electrophotographic printing methods. In some instances, the materials have difficulty obtaining a high gloss level and/or uniformity between the media and the toner. In other instances, the materials may achieve the high gloss level and/or uniformity; however, they may be unable to maintain such effects under elevated toner fusing temperatures and pressures. Further, it may, in some cases, be relatively problematic to achieve good run-ability or sheet-feeding during high speed color electrophotographic printing when using materials coated to create superior image effects.

As such, it would be desirable to provide a toner receiving composition capable of achieving a high and stable gloss level, and/or yielding gloss uniformity between the media and toner.

### SUMMARY

A toner receiving composition for electrophotographic toner receiving systems is disclosed. The composition includes a polymeric binder material and a plurality of organic hollow polymeric particles adhered to the polymeric binder material. The organic hollow polymeric particles are present in an amount equal to or greater than about 50% by weight of total solid weight of the toner receiving composition.

### BRIEF DESCRIPTION OF THE DRAWINGS

Features and advantages of the present disclosure will become apparent by reference to the following detailed description and drawings, in which like reference numerals correspond to similar, though not necessarily identical components. For the sake of brevity, reference numerals or features having a previously described function may not necessarily be described in connection with other drawings in which they appear.

FIG. 1 is a flow diagram depicting embodiment(s) of method(s) of making electrophotographic toner receiving system(s);

FIG. 2 is a cross-sectional schematic view of an embodiment of an electrophotographic toner receiving system;

FIG. 3 is a cross-sectional schematic view of an embodiment of the electrophotographic toner receiving system having a back coat;

FIG. 4 is a cross-sectional schematic view of an embodiment of the electrophotographic toner receiving system having an inorganic layer;

FIG. 5 is a cross-sectional schematic view of an embodiment of the electrophotographic toner receiving system having an embodiment of a polymer layer thereon;

FIG. 6 is a cross-sectional schematic view of another embodiment of the electrophotographic toner receiving system; and

FIG. 7 is a cross-sectional schematic view of an alternate embodiment of the electrophotographic toner receiving system.

### DETAILED DESCRIPTION

Embodiment(s) of the toner receiving composition and system advantageously achieve a high and stable gloss level when images are printed thereon via an electrophotographic printer. Generally, silver halide glossy photographic prints achieve gloss in the range of 20 gloss units to 70 gloss units when measured at a 20° angle. This range may also be desirable for high gloss media and toner when printing with an electrophotographic printer. Systems incorporating embodiments of the composition may achieve media gloss within this range and may exhibit gloss uniformity when used with an electrophotographic printer that is capable of achieving a toner gloss in this range. If the electrophotographic printer is not capable of achieving the previously described high toner gloss, in order to achieve a desirable photo-like quality, the toner receiving composition may be adjusted to enable a uniform gloss between the media and the toner at a gloss range between about 20 gloss units to about 100 gloss units when measured at a 75° angle. The toner receiving composition may be incorporated on various types of media, thus providing the media with the capability of receiving toner in a manner that yields gloss uniformity between the media and toner. Still further, it is believed that embodiment(s) of the composition and system achieve high image resolution and color gamut, thus providing photo-quality images.

It is to be understood that the terms “disposed on”, “deposited on,” or “established on” and the like are broadly defined herein to encompass a variety of divergent layering arrangements and assembly techniques. These arrangements and techniques include, but are not limited to (1) the direct attachment of one material layer to another material layer with no intervening material layers therebetween; and (2) the attachment of one material layer to another material layer with one or more material layers therebetween provided that the one layer being “disposed on,” “deposited on,” or “established on” the other layer is somehow “supported” by the other layer (notwithstanding the presence of one or more additional material layers therebetween). The phrases “directly deposited on,” “deposited directly on,” or “directly established on,” and the like are defined herein to encompass a situation(s) wherein a given material layer is secured to another material layer without any intervening material layers therebetween. Any statement used herein which indicates that one layer of material is on another layer is to be understood as involving a situation wherein the particular layer that is “on” the other layer in question is the outermost of the two layers relative to incoming toner materials being delivered by the printing system of interest (unless specifically defined otherwise). It is to be understood that the characterizations recited above are to be effective regardless of the orientation of the system materials under consideration.

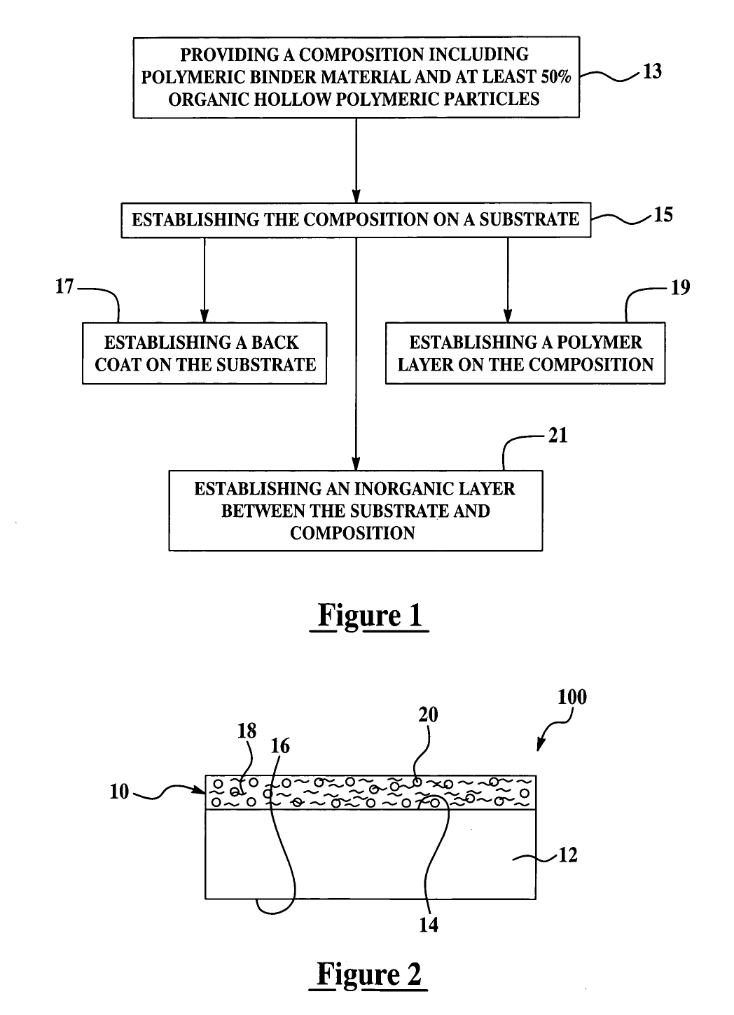

Referring now to FIG. 1, an embodiment of making an electrophotographic toner receiving system is described. A composition is provided that includes a polymeric binder material and a plurality of organic hollow polymeric particles adhered thereto, wherein the organic hollow polymeric particles are present in an amount equal to or greater than about 50% by weight of the total solid weight of the toner receiving composition, as shown at reference numeral 13. The composition is established on a substrate, as shown at reference numeral 15. The method may also include establishing a back coat on the substrate, as shown at reference numeral 17. Further, the method may include establishing a polymer layer on the composition, as shown at reference numeral 19. Still further, the method may include establishing an inorganic layer between the substrate and the composition, as shown at reference numeral 21. It is to be understood that embodiment(s) of the method will be described in further detail herein in reference to FIGS. 2 through 7.

FIG. 2 illustrates an embodiment of the toner receiving composition 10 in an embodiment of the electrophotographic in toner receiving system 100. It is to be understood that the composition 10 is adapted to form a thin-film that acts as a toner receiving layer in the system 100.

In an embodiment, the toner receiving composition 10 is established on a substrate 12. Non-limitative examples of suitable substrate 12 materials include polymeric films (non-limitative examples of which include polyester white film or polyester transparent film), papers with extruded polymer resins on both sides, polymer coextruded paper stock (cellulosic or the like), fabric paper stock, and/or combinations thereof. In an embodiment, the substrate 12 is paper, photopaper (non-limitative examples of which include polyethylene or polypropylene extruded on one or both sides of paper), metals, and/or the like, and/or combinations thereof. A non-limitative example of a suitable metal material is a metal in foil form made from, for example, at least one of aluminum, silver, tin, copper, alloys thereof, and/or mixtures thereof. Furthermore, the substrate 12 may include first and second opposed faces 14, 16 upon which various layer(s) of embodiments of the present disclosure may be established. In an embodiment, the substrate 12 has a thickness, along substantially the entire length, ranging between about 0.025 mm and about 0.5 mm.

As depicted in FIG. 2, the composition 10 may be established directly on the substrate 12. The composition 10 includes a polymeric binder material 18 and organic hollow polymeric particles 20 adhered thereto. Generally, the combination of the polymeric binder material 18 and the organic hollow particles 20 forms a composition 10 having at least one glass transition temperature (T_{g}) less than about 40° C.

The polymeric binder material 18 may be present in an amount ranging from about 5% to about 50% based on the weight of the dry coating composition. Any suitable polymeric binder material 18 may be selected as long as it is compatible with the organic hollow polymeric particles 20. Generally, the polymeric binder material 18 may be water-soluble polymers, water-dispersable polymers, polymeric emulsions, and/or combinations thereof. Specific non-limitative examples of polymeric binder materials 18 include polyvinyl alcohol, starch derivatives, gelatin, cellulose derivatives, acrylamide polymers, acrylic polymers, acrylic copolymers, vinyl acetate latex, polyesters, vinylidene chloride latex, styrene-butadiene copolymers, acrylonitrile-butadiene copolymers, styrene-acrylic copolymers, copolymers thereof, and/or the like, and/or combinations thereof.

The hollow polymeric particles 20 are present in the composition 10 in an amount equal to or greater than about 50% by weight of the total solid weight of the toner receiving composition 10. In a non-limitative example, the hollow polymeric particles 20 are present in an amount equal to or greater than about 60% by weight. Generally, each of the organic hollow polymeric particles 20 has a void volume within an outer dimension of the particle 20 that ranges from about 20% to about 70%. Still further, each of the organic hollow particles 20 has an outer diameter ranging from about 0.1 μm to about 10 μm. In an embodiment, the outer diameter of each of the particles 20 ranges from about 0.1 μm to about 4 μm, and in another embodiment, the outer diameter ranges from about 0.1 μm to about 2 μm. Some examples of suitable materials for the hollow particles 20 include, but are not limited to styrene, styrene derivatives, vinyl esters, acrylic acid polymers, ester derivatives of acrylic acid polymers, methacrylic acid polymers, ester derivatives of methacrylic acid polymers, copolymers thereof, and/or combinations thereof.

In an embodiment, the ratio of polymeric binder material 18 to organic hollow polymeric particles 20 ranges from about 1:1 to about 1:20.

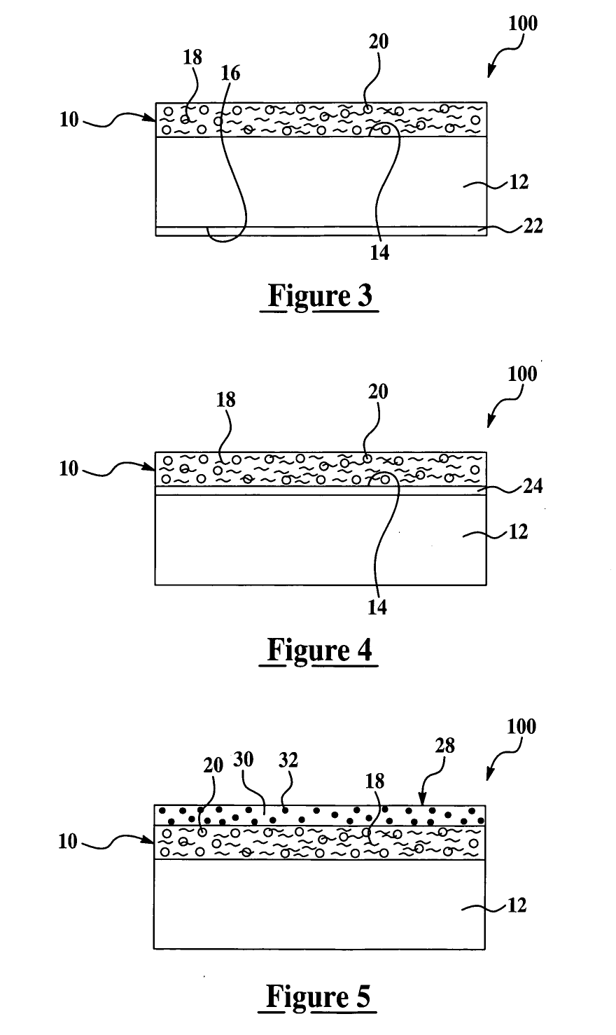

Referring now to FIG. 3, an embodiment of the toner receiving system 100 is depicted having a back coat 22 established on the substrate 12. As shown, the back coat 22 is established on the second face 16 of the substrate 12. It is to be understood that the back coat 22 may be established on either face 14,16 of the substrate 12, as long as the toner receiving composition 10 and the back coat 22 are on opposed faces 14, 16.

In an embodiment, the back coat/coating layer 22 includes inorganic pigments (a non-limitative example of which includes calcium carbonate particles), polymer particles (a non-limitative example of which includes polyethylene beads), polymeric binders, slipping agents (a non-limitative example of which includes polymeric wax), and/or the like, and/or combinations thereof. Generally, the back coat 22 may advantageously assist in controlling the friction between sheets and/or between sheets and pick-up rolls of the printer. Still further, the back coat 22 may form an open structure in the system 100 so that moisture vapor may be released from the coating 22 without causing blistering under high humidity conditions (for example, during fusing). It is to be understood that the back coat 22 may also serve to balance internal stress from layers established on opposed faces 14, 16 of the substrate 12, thus potentially minimizing curling.

Referring now to FIG. 4, another embodiment of the system 100 is depicted. In this embodiment, an inorganic layer 24 is established between the substrate 12 and the composition 10. It is to be understood that in an embodiment of the method, the inorganic layer 24 may be established on the substrate 12 prior to the establishment of the composition 10. It is to be further understood that the inorganic layer 24 may advantageously supply enhanced opacity, brightness, surface smoothness, and/or color hue to the system 100.

The inorganic layer 24 may include from about 5 parts to about 95 parts by weight of the dry layer of inorganic pigments. Non-limitative examples of such pigments include titanium dioxide, hydrated alumina (e.g. aluminum trihydrate), calcium carbonate, barium sulfate, silica, high brightness kaolin clays, calcined clays, alumina, boehmite, talc, zinc oxide, and/or combinations thereof. The inorganic layer 24 may also include a binder. Generally, the binder supplies adhesion force between the substrate 12 and the pigments, and between the pigments themselves. The binder may include, but is not limited to water soluble binders, water dispersable binders, polymeric emulsions exhibiting high binding power for the substrate 12 and the pigments, and/or combinations thereof. Non-limitative examples of binders suitable for the inorganic layer 24 include polyvinyl alcohol, starch derivatives, gelatin, cellulose derivatives, acrylamide polymers, acrylic polymers or copolymers thereof, vinyl acetate latex, polyesters, vinylidene chloride latex, styrene-butadiene, acrylonitrile-butadiene copolymers, styrene acrylic copolymers, copolymers thereof, and/or combinations thereof.

FIG. 5 depicts another embodiment of the system 100 having a polymer layer 28 thereon. Generally, the polymer layer 28 may advantageously serve to protect the composition 10 and/or add durability to the system 100. The polymer layer 28 may also enhance the gloss of the media and/or may tailor the gloss level of the media so as to become more uniform with the gloss of the toner in a particular electrophotographic printing system.

In FIG. 5, the polymer layer 28 includes a polymeric emulsion of a binder material 30 and organic solid polymeric particles 32. The organic solid polymeric particles 32 may have any suitable geometry, including, but not limited to spherical particles, or nearly spherical particles in the pre-imaged state. It is to be understood that any suitable binder material 30, such as those described herein in reference to binders used in other layers, may be used in the polymer layer 28.

Each of the solid particles 32 has a diameter ranging from about 0.1 μm to about 0.6 μm. In a non-limitative example, each of the solid particles 32 has a diameter ranging from about 0.1 μm to about 0.5 μm. Non-limitative examples of organic solid polymeric particles 32 include styrenes, styrene derivatives, vinyl esters, acrylic acid polymers, ester derivatives of acrylic acid polymers, methacrylic acid polymers, ester derivatives of methacrylic acid polymers, copolymers thereof, and/or combinations thereof. An embodiment of the system 100 including the polymer layer 28 may exhibit a media gloss ranging from about 20 gloss units to about 100 gloss units when measured at an angle of 75°.

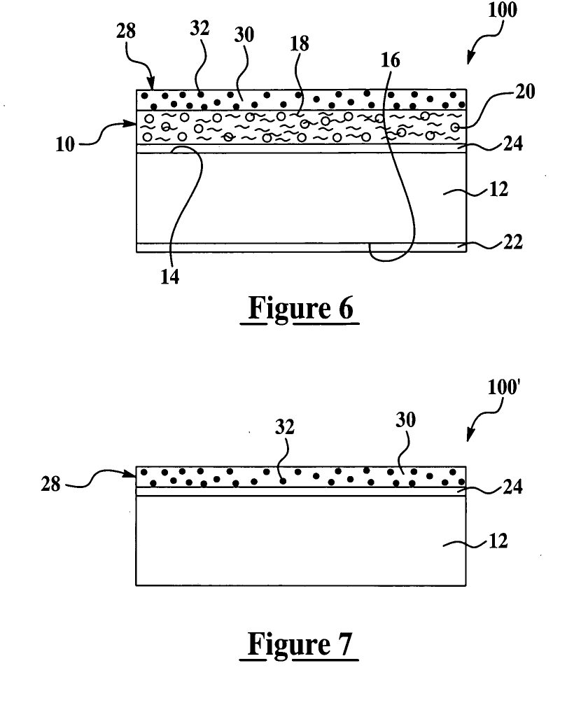

Referring now to FIG. 6, an embodiment of the system 100 may include a combination of the layer(s) disclosed herein. In the example embodiment shown, the substrate 12 has a base coat 22 established on its second face 16, and an inorganic layer 24 established on its first face 14. The composition 10 is established on the inorganic layer and forms a toner receiving layer. An embodiment of the polymer layer 28 is established on the composition 10.

In an embodiment of the method, the composition 10 is provided and is established on the substrate 12 to form a toner receiving layer. It is to be understood that the composition may be provided by mixing the polymeric binder material 18 with the organic hollow particles 20. The composition 10 may be homogeneous, heterogeneous, or a combination thereof, where portions of the composition are homogeneous and other portions are heterogeneous.

The method may also include establishing the back coat 22 on one of the first or second faces 14, 16, such that it is opposed to the composition 10. Another embodiment of the method includes establishing the inorganic layer 24 between the composition 10 and the substrate 12. Still other embodiment(s) of the method include establishing an embodiment of the polymer layer 28 on the composition 10 (i.e. toner receiving layer). It is to be understood that each of the various compositions, coatings, or layers may be established by blade coating processes, rod coating processes, air-knife coating processes, curtain coating processes, slot coating processes, cast coating processes, extrusion coating processes, transfer coating processes, size press processes, jet coating processes, or combinations thereof.

FIG. 7 depicts an alternate embodiment of the system 100′. In this embodiment, an inorganic layer 24 is established on the substrate 12. The polymer layer 28 (including the solid particles 32) is established on the inorganic layer 24. It is to be understood that the polymer layer 28 may act as a toner receiving layer.

The composition 10 and systems 100, 100′ are suitable for use in electrophotographic printing. In one non-limitative example, a surface temperature of the fuser of the printer used may range from about 50° C. to about 220° C., or from about 150° C. to about 220° C. It is to be understood that these temperatures may be suitable for deforming the organic hollow polymeric particles 20 of the system 100 to form a thin layer.

Embodiment(s) of the toner receiving composition 10 and system 100, 100′ include, but are not limited to the following advantages. High and stable gloss levels may be achieved when images are printed on embodiment(s) of the system 100, 100′ via an electrophotographic printer. The toner receiving composition 10 may be incorporated on various types of media, thus providing the media with the capability of receiving toner in a manner that yields gloss uniformity between the media and toner. Still further, embodiment(s) of the composition 10 and system 100, 100′ may achieve high image resolution and color gamut, thus substantially providing photo-quality images.

While several embodiments of the invention have been described in detail, it will be apparent to those skilled in the art that the disclosed embodiments may be modified. Therefore, the foregoing description is to be considered exemplary rather than limiting.

What is claimed is:

1. A toner receiving composition for electrophotographic toner receiving systems, the toner receiving composition comprising:
a polymeric binder material; and
a plurality of organic hollow polymeric particles adhered to the polymeric binder material, the organic hollow polymeric particles present in an amount equal to or greater than about 50% by weight of total solid weight of the toner receiving composition.

2. The toner receiving composition as defined in claim 1 wherein the plurality of organic hollow polymeric particles is present in an amount equal to or greater than about 60% by weight of total solid weight of the toner receiving composition.

3. The toner receiving composition as defined in claim 1 wherein the plurality of organic hollow polymeric particles is selected from styrene, styrene derivatives, vinyl esters, acrylic acid polymers, ester derivatives of acrylic acid polymers, methacrylic acid polymers, ester derivatives of methacrylic acid polymers, copolymers thereof, and combinations thereof.

4. The toner receiving composition as defined in claim 1 wherein each of the plurality of organic hollow polymeric particles has a void volume within an outer dimension of the particle ranging from about 20% to about 70%.

5. The toner receiving composition as defined in claim 1 wherein each of the plurality of organic hollow polymeric particles has an outer diameter ranging from about 0.1 μm to about 10 μm.

6. The toner receiving composition as defined in claim 1 wherein the polymeric binder material is selected from water-soluble polymers, water-dispersable polymers, polymeric emulsions, and combinations thereof.

7. The toner receiving composition as defined in claim 1 wherein the polymeric binder material is selected from polyvinyl alcohol, starch derivatives, gelatin, cellulose derivatives, acrylamide polymers, acrylic polymers, acrylic copolymers, vinyl acetate latex, polyesters, vinylidene chloride latex, styrene-butadiene copolymers, acrylonitrile-butadiene copolymers, styrene-acrylic copolymers, copolymers thereof, and combinations thereof.

8. The toner receiving composition as defined in claim 1 wherein at least one glass transition temperature (T_{g}) of the composition is less than about 40° C.

9. The toner receiving composition as defined in claim 1 wherein the polymeric binder material and the plurality of organic hollow polymeric particles are adapted to form a thin film on a substrate.

10. An electrophotographic toner receiving system, comprising:
a substrate; and
a toner receiving layer established on the substrate, the toner receiving layer including a polymeric binder material and a plurality of organic hollow polymeric particles adhered thereto, the plurality of organic hollow polymeric particles is present in an amount equal to or greater than about 50% by weight of total solid weight of the toner receiving layer.

11. The electrophotographic toner receiving system as defined in claim 10 wherein the plurality of organic hollow polymeric particles is present in an amount equal to or greater than about 60% by weight of total solid weight of the toner receiving layer.

12. The electrophotographic toner receiving system as defined in claim 10 wherein the plurality of organic hollow polymeric particles is selected from styrene, styrene derivatives, vinyl esters, acrylic acid polymers, ester derivatives of acrylic acid polymers, methacrylic acid polymers, ester derivatives of methacrylic acid polymers, copolymers thereof, and combinations thereof.

13. The electrophotographic toner receiving system as defined in claim 10 wherein each of the plurality of organic hollow polymeric particles has an outer diameter ranging from about 0.1 μm to about 10 μm.

14. The electrophotographic toner receiving system as defined in claim 10 wherein the polymeric binder material is selected from water-soluble polymers, water-dispersable polymers, polymeric emulsions, and combinations thereof.

15. The electrophotographic toner receiving system as defined in claim 10 wherein at least one glass transition temperature of the toner receiving layer is less than about 40° C.

16. The electrophotographic toner receiving system as defined in claim 10, further comprising a polymer layer established on the toner receiving layer.

17. The electrophotographic toner receiving system as defined in claim 16, wherein the polymer layer includes an emulsion of a binder material and a plurality of solid polymeric particles.

18. The electrophotographic toner receiving system as defined in claim 17 wherein each of the plurality of solid polymeric particles has a diameter ranging from about 0.1 μm to about 0.6 μm.

19. The electrophotographic toner receiving system as defined in claim 17 wherein each of the plurality of solid polymeric particles is selected from styrenes, styrene derivatives, vinyl esters, acrylic acid polymers, ester derivatives of acrylic acid polymers, methacrylic acid polymers, ester derivatives of methacrylic acid polymers, copolymers thereof, and combinations thereof.

20. The electrophotographic toner receiving system as defined in claim 10 wherein the toner receiving layer is established on a first face of the substrate, and wherein the electrophotographic toner receiving system further comprises a back coat established on a second face of the substrate, the second face being opposed to the first face.

21. The electrophotographic toner receiving system as defined in claim 10, further comprising an inorganic layer established between the substrate and the toner receiving layer.

22. The electrophotographic toner receiving system as defined in claim 21 wherein the inorganic layer is selected from titanium dioxide, aluminum trihydrate, calcium carbonate, barium sulfate, silica, kaolin clays, calcined clays, alumina, boehmite, talc, zinc oxide, and combinations thereof.

23. The electrophotographic toner receiving system as defined in claim 10 wherein a ratio of the polymeric binder material to the plurality of organic hollow polymeric particles ranges from about 1:1 to about 1:20.

24. The electrophotographic toner receiving system as defined in claim 10 wherein the system is adapted to receive toner via dry toner electrophotographic printing.

25. The electrophotographic toner receiving system as defined in claim 10 wherein the substrate is selected from polymeric films, paper with extruded polymer resins, fabric paper stock, and combinations thereof.

26. A method for using the electrophotographic toner receiving system as defined in claim 10, the method comprising printing indicia on the toner receiving system via a dry toner electrophotographic printer, wherein a surface temperature of a toner fuser of the dry toner electrophotographic printer ranges from about 50° C. to about 220° C.

27. A method of making an electrophotographic toner receiving system, the method comprising:
providing a composition including a polymeric binder material and a plurality of organic hollow polymeric particles adhered thereto, the plurality of organic hollow polymeric particles present in an amount equal to or greater than about 50% by weight of total solid weight of the toner receiving composition; and
establishing the composition on a substrate, thereby forming a toner receiving layer.

28. The method as defined in claim 27 wherein the composition is established on the substrate via at least one of blade coating processes, rod coating processes, air-knife coating processes, curtain coating processes, slot coating processes, cast coating processes, extrusion coating processes, transfer coating processes, size press processes, or combinations thereof.

29. The method as defined in claim 27, further comprising establishing a polymer layer on the toner receiving layer.

30. The method as defined in claim 29 wherein the polymer layer includes an emulsion of a binder material and a plurality of solid polymeric particles.

31. The method as defined in claim 30 wherein each of the plurality of solid polymeric particles has a diameter ranging from about 0.1 μm to about 0.6 μm.

32. The method as defined in claim 30 wherein each of the plurality of solid polymeric particles is selected from styrenes, styrene derivatives, vinyl esters, acrylic acid polymers, ester derivatives of acrylic acid polymers, methacrylic acid polymers, ester derivatives of methacrylic acid polymers, copolymers thereof, and combinations thereof.

33. The method as defined in claim 27 wherein the toner receiving layer is established on a first face of the substrate, and wherein the method further comprises establishing a back coat on a second face of the substrate, the second face being opposed to the first face.

34. The method as defined in claim 27, further comprising establishing an inorganic layer between the substrate and the toner receiving layer.

35. An electrophotographic toner receiving system, comprising:
a substrate;
an inorganic layer established on the substrate; and
a polymer layer established on the inorganic layer, the polymer layer including an emulsion of the binder material and a plurality of solid polymeric particles.

36. The electrophotographic toner receiving system as defined in claim 35 wherein the inorganic layer is selected from titanium dioxide, aluminum trihydrate, calcium carbonate, barium sulfate, silica, kaolin clays, calcined clays, alumina, boehmite, talc, zinc oxide, and combinations thereof.
